(19) United States
(12) Patent Application Publication
(10) Pub. No.: US 2026/0362168 A1
(43) Pub. Date: Nov. 12, 2026

(54) SYSTEMS AND METHODS FOR REAL-TIME MANAGEMENT AND OPTIMIZATION OF NON-TERRESTRIAL NETWORK (NTN) AND SUPPLEMENTAL COVERAGE FROM SPACE (SCS) RESOURCES FOR TARGETED TRAFFIC

(71) Applicant: AALYRIA TECHNOLOGIES, INC., LIVERMORE, CA (US)

(72) Inventors: STEFAN DRASKOCI, LONDON (GB); BRIAN BARRITT, PITTSBURGH, PA (US); LUCA LODIGIANI, LONDON (GB)

(21) Appl. No.: 19/666,221

(22) Filed: May 2, 2026

Related U.S. Application Data
(60) Provisional application No. 63/801,286, filed on May 7, 2025.
(60) Provisional application No. 63/886,527, filed on Sep. 23, 2025.

(51) Int. Cl. H04W 24/02; H04W 4/90; H04W 8/22; H04W 84/06

(52) U.S. Cl. CPC H04W 24/02; H04W 4/90; H04W 8/22; H04W 84/06

(57) ABSTRACT

The current disclosure utilizes data collection and network management capabilities in a telecommunications network to enable the deployment of a non-terrestrial network to supplement terrestrial network coverage during a period where the terrestrial network may experience lapses in coverage.

### CROSS REFERENCE TO RELATED APPLICATIONS

This U.S. Non-Provisional Application claims the benefit of priority U.S. Provisional Application No. 63/886,527, filed Sep. 23, 2025; and also claims the benefit of priority U.S. Provisional Application No. 63/801,286, filed May 7, 2025, the disclosures of which are incorporated by reference herein in their entirety.

### BACKGROUND

Mobile telecommunication networks may provide wireless connectivity that may enable voice, data, and/or internet services for mobile devices across wide geographic areas. Terrestrial networks may provide the ground-based infrastructure (e.g., cell towers, antennas, and/or fiber links) that may enable mobile devices to connect to the broader telecommunications system. Gaps in connectivity may exist where the deployment of terrestrial base stations has proven to be physically infeasible or commercially unavailable. Proprietary satellite systems may be utilized to serve such remote regions, however these have in most cases proven to be too inaccessible and impractical to the end user to see widespread adoption.

The 3GPP family of standards for mobile networks has achieved global adoption and usage, and has given rise to billions of mobile devices which support a number of generations of the standard (3G, 4G, 5G, etc.). The combination of these standards with the ubiquitous reach of satellites presents a compelling solution to deliver connectivity to unconnected regions and people.

This opportunity was recognized in 3GPP and has been actively addressed in recent years as a new flavor of the 5G new radio (NR) standard, called 5G Non-Terrestrial Networks (NTN). Non-Terrestrial Networks may utilize spaceborne (e.g., satellites), airborne (e.g., drones or balloons), or other non-ground-based platforms to act as a repeater of a 5G waveform which may be generated on the ground. In an example, Low Earth Orbit satellite constellations may be the preferred mode of delivery (e.g., via earth-fixed cells or satellite-fixed cells). In this example, a 5G next generation Node B (gNodeB or gNB) Radio Access Network (RAN) stack may generate a downlink (DL) NR-Uu waveform that may be transmitted by a NTN gateway to the LEO satellite(s) via a feeder link, where the NR-Uu waveform may be repeated, typically on another frequency, and retransmitted down to a terrestrial mobile device, a user equipment (UE), on a service link. In contrast, an uplink NR-Uu waveform may follow a reverse path, being transmitted by the UE via the service link to the LEO satellite(s), where the signal is retransmitted via the feeder link down to the NTN gateway and 5G gNodeB RAN.

In some examples, RAN components may be proprietary or tightly integrated by a single vendor. In other examples, such as an Open Radio Access Network (O-RAN), the RAN may be split into modular components that may come from different vendors. The O-RAN may include a radio unit to handle radio frequency transmissions and reception. A Service Management and Orchestration (SMO) may be a component in the O-RAN architecture responsible for managing or orchestrating the lifecycle of RAN components (e.g., gNBs, RIC Applications (rApp), or extensible applications (xApp)); provisioning, monitoring, or optimizing network functions; hosting rApps; or interfacing with operations support systems or other management systems. The O-RAN may further include a distributed unit to process real-time data like scheduling or beamforming. The O-RAN may further include a central unit and RAN Intelligent Controller (RIC). In some examples, the RIC may include a Near-Real-Time (RT) RIC and/or a Non-RT RIC. In these examples, the Near-RT RIC may enable real-time control. The non-RT RIC may enable long-term optimization or policy management. The use of open interfaces may enable the equipment from different vendors to work together. An RIC Application (rApp) may run on the Non-RT RIC to enable policy management, machine learning model training, network optimization, long term analytics or other functions.

Subsequent releases of 3GPP may tackle the complexities of hosting a 5G gNodeB onboard satellites, and having the capability to route traffic flows over Inter-Satellite Links (ISLs) to other satellites. These kinds of networks may offer greater flexibility to the end-to-end delivery of connectivity, but in doing so they may also increase operational complexity.

Over time, Direct-to-Device 5G NTN services will evolve towards being capable of delivering higher data rates to the UE(s) to support different services.

The market is trending towards 5G NTN constellations being owned and operated by incumbent and emerging Satellite Network Operators (SNOs), who are distinct to the terrestrial Mobile Network Operators (MNOs) whose coverage gaps they are filling. Supplemental Coverage from Space (SCS) may provide an example in which SNO coverage may fill coverage gaps in the MNO coverage. Each independent 5G NTN constellation is intended to act as a logical extension of a number of 5G terrestrial networks all over the world, where the mobile devices are expected to roam onto the former in the absence of the latter. The end goal is to enable mobile users to consume connectivity services with minimal impact on their perceived experience, including seamless transitions/handovers between 5G Terrestrial Networks (TNs) and 5G NTNs. A key challenge in achieving this end goal is that the current 3GPP standards do not sufficiently address the architectural implementations and processes by which 5G TNs and NTNs will integrate and coordinate at the RAN and Core levels, to allow mobile devices (UEs) to be seamlessly handed over from one to the other.

Terrestrial network coverage gaps are in some cases quite wide, while in other cases significantly smaller. A UE driving on a highway might leave, re-enter, and again leave the terrestrial coverage area every couple of minutes. In order to assure seamless consumption of connectivity services, the network should be capable of maintaining voice and data-based conversations (e.g., WhatsApp) during the handovers between the TN and the NTN. In handover events between terrestrial base stations, this is achieved either by having an interface between the two gNodeBs which allows them to coordinate (e.g., the Xn interface), or by having them do so via their common Core Network (e.g., via the Next Generation (NG) interface). The establishment of this kind of interfacing on a global scale between the SNOs and various MNOs would be very difficult to achieve. As such, another key challenge is that current 3GPP standards for 5G NTN account for traditional mobile roaming between operators as being the handover procedure for transitions between the two, which would pose a significant interruption for a user to their consumption of connectivity services.

There are new NTN control plane signaling measures that were introduced by 3GPP to aid UEs for the initial access and mobility procedures, such as the System Information Block 19 (SIB19). These are intended to be unicast or broadcast by the TN RAN to UEs which are soon to be connected to the NTN network. The UEs use this information about their target satellite to properly synchronize in time and frequency with the NTN segment, to facilitate TN-to-NTN handover. In integrated TN and NTN environments, maintaining seamless coverages is challenged by dynamic conditions that may introduce or exacerbate coverage gaps within or between the two domains. Factors such as atmospheric interference, terrain obstructions, and satellite beam transitions can disrupt connectivity. These disruptions may necessitate mechanisms for proactive planning and real-time awareness to ensure continuity in network coverage. These mechanisms may include systems or methods to anticipate, detect, or respond to coverage gaps between TN and NTN, including SCS, to maintain reliable communication across diverse contexts.

A real-time determination of telecommunications network (e.g., TN or NTN) capabilities may be necessary for a plurality of reasons. In an example, an emergency may detrimentally impact the ability of a network to provide coverage to UEs in the network's coverage area. A lack of network coverage in an area may negatively affect emergency response coordination, public safety, infrastructure assessment, business continuity, data integrity and security, or community support.

Reliable or efficient communication for various UEs may be paramount for telecommunications networks. In situations that may limit the availability of telecommunications network resources, the available resources may be allocated to enable their use by priority UEs. In those situations, such as emergencies or natural disasters, the ability of the priority users to communicate swiftly and effectively may have significant impacts on the outcome of their operations.

During emergencies, networks may experience heavy congestion due to increased usage by the general population. This surge in network traffic may lead to delays, dropped calls, and reduced data speeds, hindering the ability of emergency responders, or other priority users, to coordinate or respond effectively. There may be a need for uninterrupted and prioritized communication in such scenarios.

### SUMMARY

The current disclosure utilizes an NTN/SCS RIC to provide a real-time response to a detection of outages of one or more cells in a TN to ensure continuous network coverage. The disclosed subject matter may further utilize the NTN/SCS RIC to optimize resources for priority UEs.

In an aspect of the present disclosure, a method may be provided for real-time management and optimization of non-terrestrial network (NTN) resources for priority coverage. The method may include steps of: (A) detecting an outage in a number of cells in the terrestrial network; (B) activating, using a nonterrestrial network (NTN) controller, an NTN, wherein the NTN comprises one or more target areas, one or more target cells, one or more frequencies for the NTN, a reference configuration, and an interference threshold map for one or more adjacent active network cells; (C) determining, using the NTN controller, an NTN network cell coverage plan; in which the NTN network cell coverage plan is based on the target area and an interference to noise ratio threshold map; (D) determining one or more network cell parameters, ground station radio frequencies, and ground station gateway parameters, in which the one or more network cell parameters are used to integrate NTN platform systems with terrestrial networks; (E) configuring one or more base station basebands, cluster, and ground segment transmit/receive chains, including the cell to beam map; (F) sending a call-back to a network management application in the TN network to notify deployment of NTN coverage, in which the call-back comprises the NTN cell configuration; (G) sending a request for creating a network slice in the NTN dedicated to one or more priority user equipment and one or more priority traffic types, in which the one or more priority user equipment (UE) and one or more priority traffic types are received by the network management application; (H) sending the one or more priority UE, traffic types, and network capabilities to the non-terrestrial network manager in the NTN; (I) determining NTN capabilities to integrate one or more NTN platforms to provide network coverage with a determined capacity, spectrum, beam duty cycle and power for one or more target areas; (J) determining one or more resources for one or more prioritized UE and traffic types to support one or more capabilities, wherein the one or more capabilities comprises voice, data, and video streaming; and (K) determining one or more second resources for nonprioritized UE to enable one or more second capabilities, wherein the one or more second capabilities comprise messages and emergency messages.

In an example aspect, the method may further include determining a threshold number of operating network cells to maintain a terrestrial network and a determination that the number of operating network cells is below the threshold number. In another aspect, the NTN platforms may include one or more satellites, one or more high altitude platform stations, one or more unmanned aerial vehicles, and one or more manned aerial vehicles. In yet another aspect, the NTN may include a supplemental coverage from space network, in which the NTN platform systems include one or more satellite systems.

### DESCRIPTION OF THE DRAWINGS

FIG. 1A is a diagram of an example telecommunications network in accordance with an example of the present disclosure.

FIG. 1B is a diagram of an example telecommunications network in accordance with an example of the present disclosure.

FIG. 1C is a diagram of an example telecommunications network in accordance with an example of the present disclosure.

FIG. 1D is a diagram of an example telecommunications network in accordance with an example of the present disclosure.

### DETAILED DESCRIPTION

The control of NTN resources to supplement TN resources (e.g., in SCS) may enable continuous network coverage for a target area, even when one or more cells in the TN of the target area are disabled. The one or more cells may become disabled for a number of reasons, including natural disasters. The disclosed subject matter may enable the use of an NTN/SCS RIC to detect outages of one or more cells in a TN.

The disclosed subject matter may further enable the prioritization of one or more UEs for coverage in a network. In some examples, in the area where the one or more cells may have become disabled, prioritizing one or more UEs for use in a target coverage area that includes the disabled cell(s) may enable the use of the one or more UEs in that area. For example, in response to detecting one or more disabled cells in a coverage area due to a natural disaster (e.g., severe weather), the disclosed method may include prioritizing network coverage for one or more UEs being used by first responders (e.g., police or paramedics).

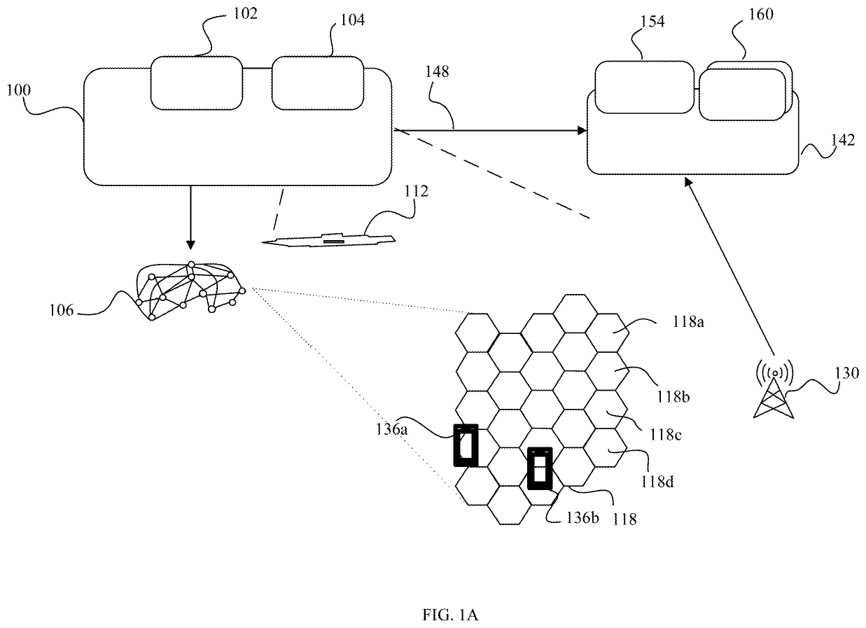

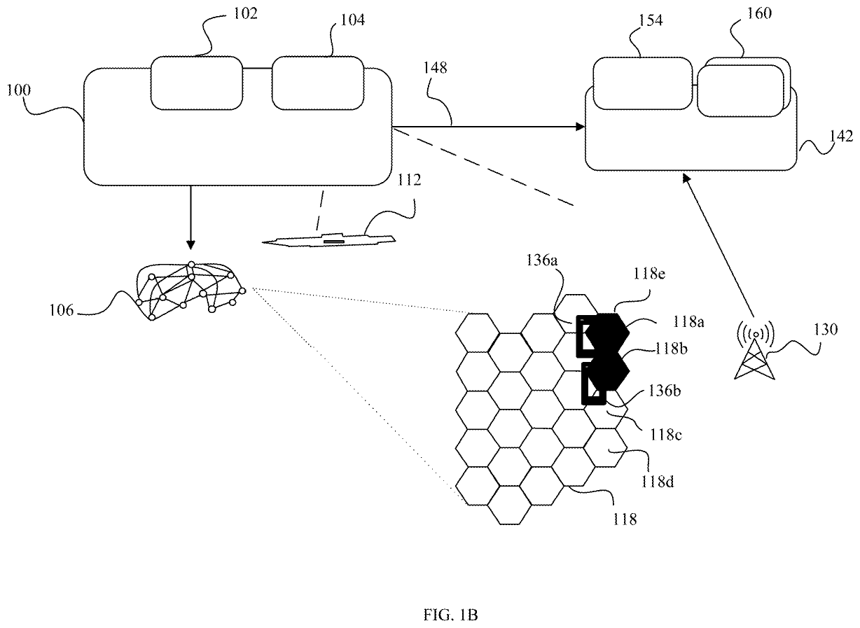

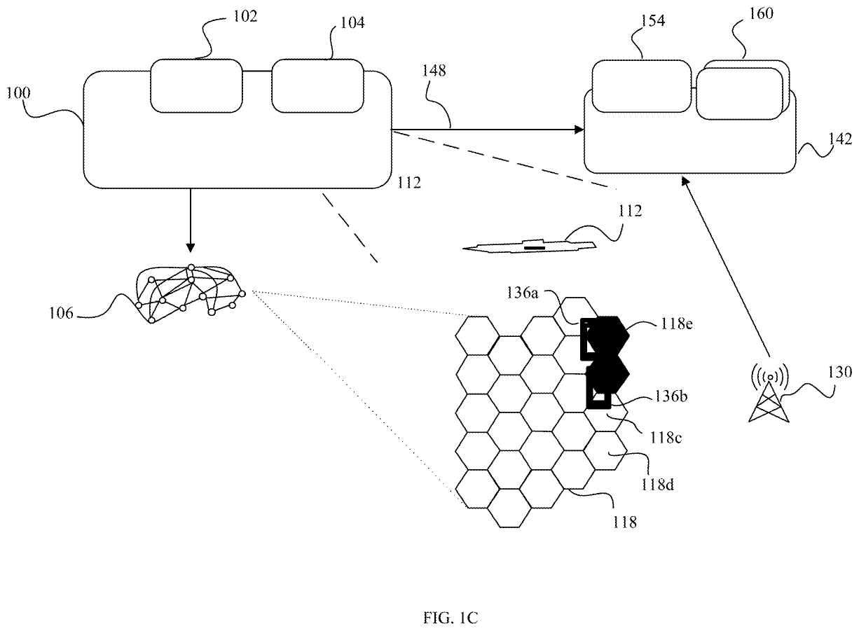

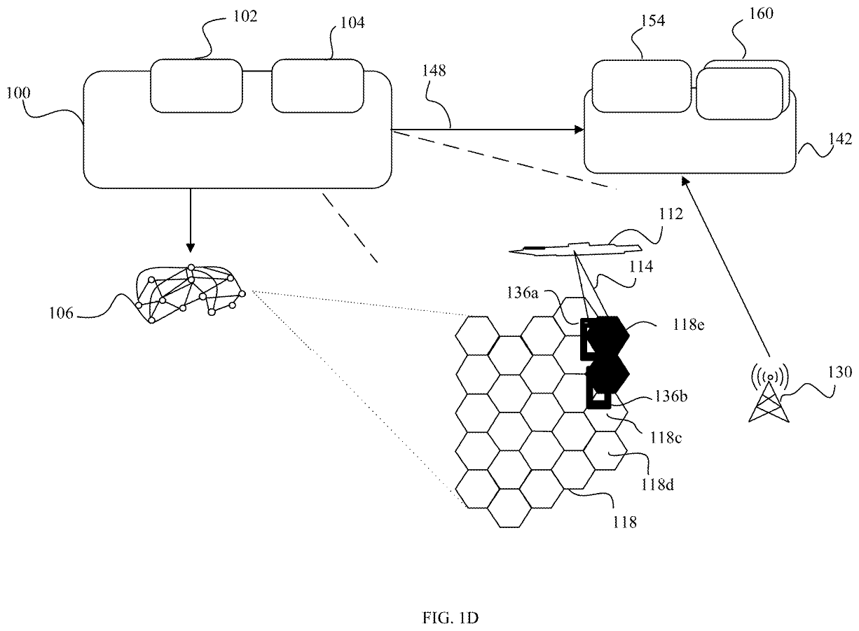

FIGS. 1A and 1B are example telecommunications networks with coverage provided by a terrestrial network and a non-terrestrial network in accordance with an example of the present disclosure. As illustrated in FIGS. 1A-1D, a telecommunications network may include network cell 118a-118d, which may be grouped together to form mosaic 118. It should be recognized the mosaic 118 may represent a group of one or more individual network cell(s). For example, mosaic 118 may include 25 individual cells. At FIGS. 1A-1D, network cell 118 a-118d may include one or more geographic areas that may be covered by a TN or NTN to enable signal availability and connectivity in network cell 118a-118d to one or more user devices (e.g., UE 136a and/or UE 136b). At FIGS. 1A-1D, mosaic 118 may be covered by a TN and/or NTN.

As illustrated in FIGS. 1A-1D, the TN may include base station 130. At FIGS. 1A-1D, base station 130 may include ground-based infrastructure that may facilitate wireless communication between one or more user devices (e.g., UE 136a and/or UE 136b). It should be recognized that the TN may include more than one base station. For example, the TN may include 30 base stations. In some examples, the TN may include base stations, remote radio heads (RRHs), distributed antenna systems (DAS), backhaul and fronthaul links, and/or power supply and cooling systems. In some examples, base station 130 may include a space array antenna. In some examples, base station 130 may cover a single network cell. For example, base station 130 may cover network cell 118a. In other examples, base station 30 may cover multiple network cells. For example, base station 130 may cover network cell 118a, network cell 118b, and network cell 118c.

At FIGS. 1A-1D, UE 136a and/or UE 136b may include consumer devices (e.g., smartphones, tablets, laptops, and/or wearables), fixed wireless devices (e.g., home routers and/or satellite terminals), Internet of Things (IOT) or machine-to-machine (M2M) devices (e.g., smart meters, connected vehicles, industrial sensors, and/or asset trackers), industrial equipment (e.g., ruggedized handhelds, private network terminals, and/or mission-critical communication devices), and/or specialized equipment (e.g., drones with cellular or satellite connectivity, augmented or virtual reality headsets, and/or medical devices with telemetry features).

As illustrated in FIGS. 1A-1D, the NTN may include platform 112. In some examples, platform 112 may cover a single network cell. For example, platform 112 may cover network cell 118d. In other examples, platform 112 may cover multiple network cells. For example, platform 112 may cover network cell 118c and network cell 118d. It should be recognized that the NTN may include more than one platform. For example, the NTN may include 20 platforms. In some examples, platform 112 may be a part of an SCS network which may include one or more satellite components. For examples, platform 112 may be a LEO satellite. In other examples, platform 112 may include an airborne component. For example, platform 112 may be an unmanned aerial vehicle (UAV). It should be recognized that the NTN may include one or more satellite components and one or more airborne components.

At FIGS. 1A-1D, the NTN may include controller 100. In some examples, controller 100 may be an RIC. For example, controller 100 may be an SMO RIC, Non-RT RIC, and/or Near-RT RIC. In some examples, controller 100 may be utilized to coordinate the deployment of platform 112. In some examples, controller 100 may perform one or more functions in conjunction with an E2 interface. For example, controller 100 may enable self-organizing network (SON) or inter-cell interference coordination (ICIC) functions via an O-RAN. At FIGS. 1A-1D, controller 100 may include a solver configured to optimize an NTN, process inputs from a network, and/or support rApps and/or xApps. In some examples, the solver may be a part of an artificial intelligence (AI) decision-making loop. For example, the AI decision-making loop may include a prediction model, an optimization-based model, or both. In an example of a predictive model, the solver may be configured to forecast when an outage of a network cell (e.g., network cell 118a) may occur and/or a trajectory of a user device (e.g., UE 136a). In an example of an optimization-based model, the solver may be configured to determine the best configuration of a coverage area (e.g., mosaic 118) to maintain coverage. In these examples, as conditions change, the system may refine its predictions and/or re-optimize coverage areas. AI, machine learning (ML) model, large language model (LLM), and neural network (NN) may be used interchangeably herein. For example, the solver may use ML models trained on historical and/or simulated NTN data. For another example, the solver may run optimization algorithms. At FIGS. 1A-1D, controller 100 may support application 102 and application 104. In some examples, application 104 may include xApp and/or rApps for network coverage management. In some examples, application 102 may include NTN xApps and/or rApps. For example, application 102 may include SCS rApps.

At FIGS. 1A-1D, controller 100 may detect a mixed network that may include base station 130, UE 136a, UE 136b, platform 112 and mosaic 118. As illustrated in FIGS. 1A-1D, controller 100 may generate model 106 of the mixed network. In some examples model 106 may include an internal representation of the NTN and TN that may be used for planning or real-time adjustments while providing network connectivity. In some examples, model 106 may be an internal topology model. At FIGS. 1A-1D, model 106 may further include an interference-to-noise (I/N) threshold map. In some examples, the I/N threshold map may include a spatial representation of the I/N ratio across mosaic 118, compared against a defined threshold. The I/N threshold map may be used to assess or visualize interference conditions across the network. At FIGS. 1A-1D, controller 100 may provide notification of UEs joining and/or traversing the NTN (e.g., the SCS network).

At FIGS. 1A-1D, MNO 142 may detect signal information from network cell 118a-118d. MNO 142 may own or control the TN. In this way, MNO 142 may control base station 130 to provide coverage from mosaic 118. As illustrated in FIGS. 1A-1D, interface 148 may include an application programming interface that may enable communication or interoperability between controller 100 and MNO 142. In some examples, controller 100 and MNO 142 may communicate to enable coordination of the NTN and TN to provide coverage for user devices as the move between network cells. For example, interface 248 may enable roaming of UE 136a between coverage from platform 112 and base station 130. At FIGS. 1A and 1B, MNO 142 may record signal levels from network cell 118a-118d that may be serving UE 136a or UE 136b. In some examples, the measurements may be reported to MNO 142 by base station 130. In other examples, MNO 142 may include a self-organizing network (SON) that may be utilized by MNO 142 to automatically configure new base stations that may be added to the network, continuously adjust parameters (e.g., power levels or handover thresholds) to improve network performance, and/or detect and compensate for network faults or outages. For example, MNO 142 may utilize the SNO to optimize handover between base station 130 and platform 112. At FIGS. 1A-1D, measurements from UE 136a, UE 136b, and/or network cell 118a-118d may be reported to the SON.

As illustrated in FIGS. 1A-1D, MNO 142 may include a network management system (e.g., non-RT RIC) that may include application 154 and applications 160 that may run within the network management system. In some examples, application 154 may include a broker application that may facilitate communication, coordination, and/or data exchange between different applications or systems (e.g., rApps, xApps, and/or RICs). In some examples, applications 160 may include one or more rApps and/or xApps that may run on the TN.

As illustrated in FIG. 1A, a mixed network may include a TN and an NTN. As illustrated in FIG. 1A, the NTN may include platform 112 at a first position, and the TN may include base station 130. At FIG. 1A, controller 100 may communicate with MNO 142 via interface 148 to provide network coverage for mosaic 118. As illustrated in FIG. 1A, UE 136a and UE 136b may be at a first position in mosaic 118. At FIG. 1A, UE 136a and UE 136b may be able to utilize one or more network services via mosaic 118. In some examples, the one or more network services include access to the internet, cellular phone services, and/or messaging services. In some examples, UE 136a and/or UE 136b may be mobile. For example, UE 136a may move from network cell 118d to network cell 118a. In some examples, platform 112 or base station 130 may provide network service to UE 136a and/or UE 136b depending on their location. For example, platform 112 may provide coverage for UE 136a if it is located in network cell 118a, but base station 130 may provide coverage for UE 136a if it is located in network cell 118c. At FIG. 1A, controller 100 ensures seamless coverage for UE 136a and UE 136b across mosaic 118 such that UE 136a and UE 136b may move across mosaic 118 and switch between platform 112 and base station 130 for coverage with no interruption in service.

As illustrated in FIG. 1B, UE 136a and UE 136b may be at a second position in mosaic 118. In some examples, UE 136a may be in network cell 118a and UE 136b may be in network cell 118b. At FIG. 1B, there may be an outage in network cell 118a and network cell 118b. It should be recognized that any one or more network cells in mosaic 118 may experience an outage. For example, network cell 118d may experience an outage alone. For another example, mosaic 118 may experience a complete outage. In some examples, the outage may be due to an emergency condition. For example, the outage may be due to a natural disaster (e.g., tornado, hurricane, or ice storm). In other examples, the outage may be due to a malicious action against one or more components of the TN. For example, the outage may be due to a cyber attack (e.g., jamming, spooring, or cyber intrusion). For another example, the outage may be due to a targeted attack against base station 130.

At FIG. 1B, controller 100 may detect an outage in network cell 118a and network cell 118b. In response to the detection of the outage, controller 100 may utilize application 104 and/or support application 102 to activate platform 112. For example, controller 100 may utilize an rApp to activate platform 112. In some examples, controller 100 may activate an NTN. For example, controller 100 may activate and SCS, in which platform 112 is a satellite in a constellation of satellites. In some examples, MNO 142 may detect the outage in network cell 118a and network cell 118b. In these examples, to initiate a request via an interface 148 to controller 100 for activation of platform 112 (e.g., the SCS). At FIG. 1B, the request for platform 112 (e.g., the NTN) activation may contain a target area and/or cells (e.g., network cell 118a and network cell 118b), temporarily available frequencies, a reference configuration, and/or an interference threshold map for adjacent active cells. In some examples, the frequencies may be set aside prior to activation of platform 112 to be made available upon activation of platform 112. In another example aspect, platform 112 may further be activated with a reference configuration (e.g., Absolute Radio Frequency Channel Number; channel bandwidth; or Random Access Channel Configuration).

At FIG. 1B, controller 100 may receive the request information via interface 148. In some examples, controller 100 may determine the request information upon the determination that platform 112 is needed. At FIG. 1B, in response to the information, controller 100 may compute an optimal beam or cell coverage plan. In some examples, the beam or cell coverage plan may be based on a target area (e.g., network cell 118a and network cell 118b) and/or an interference to noise threshold map. In some examples, a threshold number of network cells may be set to maintain the terrestrial network, and in response to a determination that the outage has caused the number of operating cells to go below the threshold number, controller 100 may compute the beam or cell coverage plan. For example, the threshold number may be set at six cells operating in mosaic 118, and the outage has taken the number of operating cells to four. At FIG. 1B, controller 100 constructs network cell 118e with one or more parameters, ground station radio frequency (RF) and/or gateway (GW) parameters. In some examples, network cell 118e may be a network cell covering the outage area. For example, network cell 118e may cover both network cell 118a and network cell 118b. In other examples, network cell 118e may cover a portion of the outage area. For example, network cell 118e may cover network cell 118a. In some examples, the network cell 118e parameters may be NR cell parameters. In other examples, the network cell 118e parameters may be LTE cell parameters. At FIG. 1B controller 100 may further configure the gNB baseband cluster and/or the ground segment transmit/receive chain, which may include a cell-to-beam map. In some examples, controller 100 may configure an evolved Node B (eNB) baseband cluster. At FIG. 1B, controller 100 may activate network cell 118e with the reference configuration. In some examples, controller 100 may create network cell 118e with the reference configuration. In other examples, controller 100 may read existing NR cell and/or LTE cell parameters, update the network cell 118e parameters to the reference configuration, and/or delete an NR cell and/or LTE cell. At FIG. 1B., controller 100 may send a call-back to an application 154 in MNO 142 to provide a notification of deployment of the platform 112. In some examples, the callback may include the network cell 118e configuration.

As illustrated in FIG. 1C, controller 100 has deployed platform 112 to provide network coverage for network cell 118e. As illustrated in FIG. 1C, UE 136a and UE 136b may be located in network cell 118e. In this way, controller 100 may provide network coverage for UE 136a and UE 136b in a location that had previously experienced an outage. At FIG. 1C, controller 100 may coordinate with MNO 142 to provide NTN resources (e.g., platform 112) to supplement the TN (e.g., base station 130). It should be recognized that controller 100 may provide NTN resources to respond to an outage in any portion of mosaic 118. For example, in response to an outage in network cell 118d, controller 100 may deploy platform 112 (or another platform) to provide network coverage.

At FIG. 1C, a determination may be made that UE 136a may be a priority for receiving network coverage over any other user devices (e.g., UE 136b) in network cell 118e. In some examples, the outage may have been a result of a natural disaster, and the priority user device may be a first responder. For example, UE 136a may belong to police. For another example, UE 136a may belong to the National Guard. In some examples, a predetermined list of priority user devices may be used to determine that UE 136a is a priority user device. In other devices one or more attributes of UE 136a and UE 136b may be considered to determine that UE 136a is a priority user device. For example, and not by way of limitation, the one or more attributes may include service type, quality of service (QOS) requirements, location, and/or mobility patterns. At FIG. 1C, in response to the determination that UE 136a is a priority device, MNO 142 may initiate a request via application 154 for the creation of a network slice (e.g., network slice 114 from FIG. 1D) in the NTN. At FIG. 1C, controller 100, in conjunction with MNO 142, may determine any resources available for the network slice based on a forecast movement of UE 136a, the network cell outage(s), and/or NTN resource (e.g., platform 112) availability and slant range dynamics.

At FIG. 1C, the network slice may be reserved for UE 136a. In some examples, controller 100 may initiate the creation of a network slice via application 102 or application 104. In some examples, the network slice may be configured with specific Quality of Service, Priority, and Preemption (QPP) characteristics. At FIG. 1C, MNO 142 may send a list of priority UE (e.g., UE 136a), traffic types, and/or network capabilities needed by UE 136a to be prioritized in the network slice to application 154. In some examples, MNO 142 may send the list of priority UE (e.g., UE 136a), traffic types, and/or network capabilities needed by UE 136a to controller 100 via interface 148.

At FIG. 1D in response to the request, controller 100 may determine a capacity (e.g., spectrum, beam duty cycle, or power) required to provide network coverage for UE 136a in network cell 118e. As illustrated in FIG. 1D, controller 100 may create network slice 114, and may utilize platform 112 to provide coverage for network cell 118e in support of UE 136a. In some examples, and not by way of limitation, the creation of slice 114 may include coordination between controller 100 and MNO 142 that may be facilitated via standardized APIs and control interfaces, allowing for service continuity, prioritized access, and interference-aware spectrum deployment. In these examples, the system may form a closed-loop decision-making process that may continuously adapt to changing network conditions and user demands. It should be recognized that network slice 114 may be utilized to support UE 136a and/or other priority UE in the network slice 114. For example, upon a determination that UE 136b is a priority, network slice 114 may provide coverage for UE 136a and UE 136b using platform 112. At FIG. 1D, controller 100 may configure the gNB scheduler to apply Quality of Service (QOS) or service-aware resource optimization and/or beam scheduling to enable network coverage of UE 136a in network slice 114. In some examples, network cells outside of the target area (e.g., network cell 118c and network cell 118d) may experience reduced coverage or degraded network performance. At FIG. 1D, controller 100 may access or update QoS parameters for a data session in the network. In some examples, controller 100 may access and/or update the parameters (e.g., for video, voice, or background data) for one or more data radio bearers (DRB) that may connect a UE to the network. In other examples, controller 100 may modify physical resource block (PRB) for network slice 114 to ensure sufficient resources are available for the UE 136a. At FIG. 1D, controller 100 may determine PRB usage information. In some examples, controller 100 may determine PRB usage information of the UE 136a in network slice 114.

At FIG. 1D, resources in network slice 114 for UE 136a may support high priority voice, data, and/or video streaming. In an example, network slice 114 may utilize resources to enable one or more tasks related to UE 136a. For example, network slice 114 may utilize resources for video streaming from unmanned aerial vehicles. At FIG. 1D, controller 100 may bar access to the network. In some examples, controller 100 may determine a Random Access Channel (RACH) backoff configuration to reduce congestion in network slice 114 or increase the efficient operation of network slice 114.

At FIG. 1D, controller 100 may allocate platform 112 (e.g., other NTN resources) to allow UE 136b (e.g., a nonprioritized UE) to utilize one or more network services. For example, the controller 100 may provide resources to enable the UE 136b to use priority messaging (e.g., emergency messaging) to text emergency services and/or their next of kin. In this way, the general public may utilize network resources for communication without disrupting network services to the prioritized UEs. At FIG. 1D, controller 100 may further provide one or more decisions or policies to a gNB to enable the gNB to execute a radio resource control (RRC) release. In this way, controller 100 may enable freeing resources to support the UE 136a in network slice 114. In an example, the RRC release may be conducted for instances of resources in contention with UE 136a. For example, the RRC release may be conducted for instances of resource contention with prioritization of first responders.

1. A method for real-time management and optimization of non-terrestrial network resources for priority coverage, the method comprising:
detecting an outage in a number of cells in a terrestrial network (TN);
activating, using a nonterrestrial network (NTN) controller, an NTN, wherein the NTN comprises one or more target areas, one or more target cells, one or more frequencies for the NTN, a reference configuration, and an interference threshold map for one or more adjacent active network cells;
determining, using the NTN controller, an NTN network cell coverage plan; wherein the NTN network cell coverage plan is based on the target area and an interference to noise ratio threshold map;
determining one or more network cell parameters, ground station radio frequencies, and ground station gateway parameters, wherein the one or more network cell parameters are used to integrate NTN platform systems with terrestrial networks;
configuring one or more base station basebands, cluster, and ground segment transmit/ receive chains, including a cell to beam map;
sending a call-back to a network management application in the TN network to notify deployment of NTN coverage, wherein the call-back comprises the NTN cell configuration;
sending a request for creating a network slice in the NTN dedicated to one or more priority user equipment (UE) and one or more priority traffic types, wherein the one or more priority UE and one or more priority traffic types are received by the network management application;
sending the one or more priority UE, traffic types, and network capabilities to the non-terrestrial network manager in the NTN;
determining NTN capabilities to integrate one or more NTN platforms to provide network coverage with a determined capacity, spectrum, beam duty cycle and power for one or more target areas;
determining one or more resources for the one or more priority UE and the traffic types that have been prioritized to support one or more capabilities; and
determining one or more second resources for UE that have not been prioritized to enable one or more second capabilities.

2. The method of claim 1, further comprising determining a threshold number of operating network cells to maintain the TN and determining that the number of operating network cells is below the threshold number.

3. The method of claim 1, wherein the NTN platforms comprise one or more satellites, one or more high altitude platform stations, one or more unmanned aerial vehicles, and one or more manned aerial vehicles.

4. The method of claim 1, wherein the NTN comprises a supplemental coverage from space network, wherein the NTN platform systems comprise one or more satellite systems.

5. The method of claim 1, wherein the one or more capabilities comprises voice, data, and video streaming.

6. The method of claim 1, wherein the one or more second capabilities comprise messages and emergency messages.

7. The method of claim 1, wherein a need for the priority coverage is based on a natural disaster impacting the TN.
